(19) United States
(12) Patent Application Publication
(10) Pub. No.: US 2009/0306884 A1
(43) Pub. Date: Dec. 10, 2009

(54) DISPLAY DEVICE FOR DISPLAYING A TRAVEL ROUTE

(75) Inventor: Guido Mueller, Quedlinburg (DE)

Correspondence Address: KENYON & KENYON LLP, ONE BROADWAY, NEW YORK, NY, 10004, US

(73) Assignee: ROBERT BOSCH GMBH, STUTTGART (DE)

(21) Appl. No.: 12/442,506

(22) PCT Filed: Aug. 3, 2007
(86) PCT No.: PCT/EP07/58093

§ 371 Date: Jul. 29, 2009

(30) Foreign Application Priority Data
Sep. 21, 2006 (DE) 2006-044-438.8

(51) Int. Cl. G01C 21/36

(52) U.S. Cl. 701/200

(57) ABSTRACT

A display device is for displaying a travel route, the travel route including a chain of route elements, and each route element having a measured value and a quantity of attributes. The display device includes a partial chain ascertainer, a calculation unit, a sorter, and a display unit. For each attribute of at least one route element the partial chain ascertainer determines a continuous partial chain of route elements of maximum length, including the route element, that have an identical attribute. For each partial chain, the calculation unit calculates an individual total measured value from the measured values of the route elements of the partial chain. The sorter sorts the quantity of attributes for the at least one route element into a sequence of hierarchical levels according to a quantitative relation of the total measured values of the partial chains of the attributes, and the display unit displays the attributes of the at least one route element in a hierarchical representation in accordance with the hierarchy levels.

### FIELD OF THE INVENTION

The present invention relates to a display device for displaying a travel route, to a navigation system for navigating along a travel route and having such a display device, and to a method for displaying a travel route.

### BACKGROUND INFORMATION

Depending on the calculation criterion, vehicle navigation systems or also route-calculation programs determine the optimal route between a starting point and a destination of a trip along the corresponding traffic route network. The result, that is to say the route, is visually marked on a map by marking the road segments to be used. Another possibility consists of displaying a list with the designations of the road segments to be utilized, i.e., a route information list, as it is commonly referred to. In this context it is desirable to present the route to the user in compact and comprehensible form and to display the corresponding details if necessary. In addition, a route information list offers the possibility of presenting supplementary information that would otherwise be impossible or very difficult to convey.

In different systems, e.g., in Blaupunkt navigation systems of the DX or EX series, only road names and numbers are used as designation. The road segments bearing the same complete designation are combined into an entry in the list. In remote regions, however, it is difficult for the user to orientate himself by road designations alone.

Other systems not only list the designations of the road segments themselves, but also the associated political regions, such as town or county names, which improves the comprehensibility. To avoid additional redundancies, the road segments within a region are properly assigned by the subordination. While the additional region designations improve the comprehensibility, the increased wealth of information adversely affects the clarity. By suppressing the traffic routes in designated areas that are unimportant for the overview, the transparency is able to be improved slightly without significantly dispensing with information that appears of little use at first glance. Beginning with the limitation of the line numbers to 6 to 10 lines in the display of typical driver information systems, it becomes clear that the route description by such a text list is hardly practical despite the combination.

Given these facts, there is a need to present the user with a very compact and clear display of the route course in the route information list and in so doing offer him the option of refining the succinctly combined information, if desired.

### SUMMARY

According to the present invention, a display device is provided for displaying a travel route, the travel route including a chain of route elements, and each route element having a measured value and a quantity of attributes. The display device includes a partial chain ascertainer, a calculation unit, a sorter, and a display unit. For each attribute of at least one route element the partial chain ascertainer determines a continuous partial chain of route elements having a maximum length and including the route element, that have an identical attribute. For each partial chain, the calculation unit calculates an individual total measured value from the measured values of the route elements of the partial chain. The sorter sorts the quantity of attributes for the at least one route element into a sequence of hierarchical levels according to a quantitative relation of the total measured values of the partial chains of the attributes, and the display unit displays the attributes of the at least one route element in a hierarchical representation in accordance with the hierarchy levels.

The display device according to the present invention allows the travel route to be displayed in an especially compact and comprehensible form, since it separates relevant from less relevant information among the abundance of attributes relating to different, mutually overlapping segments of the travel route in each case, and displays the course of the route independently of its length in a manner that a viewer is able to comprehend quickly and intuitively.

According to one specific development of the present invention, the measured value of a route element is a function of a travel distance and a travel time of the route element. This specific embodiment is especially advantageous because, for one, conventional route planning and navigation systems provide both the travel length as well as the travel time for each route element of a planned route, so that the display device of the present specific embodiment is compatible with the data format of these systems.

For another, in this specific embodiment the relevance of attributes is evaluated on the basis of criteria that are intuitively meaningful to a user who is planning or traveling the travel route, so that the user understands the displayed route in an especially rapid and effortless manner. For example, the name of a region that is traversed on a longer stretch will be perceived as more relevant to the user than the designation of a road on which he is traveling for only a short part of the route. In the same way, the name of a town whose crossing takes longer will be considered more important than the designation of a hamlet that is crossed quickly on a thoroughfare.

The measured value preferably is the travel distance itself since the travel time may be disproportionally long on roads with which the user is unfamiliar or which he considers unimportant, whereas such a restriction does not apply to the travel distance.

According to one specific embodiment of the present invention, the total measured value of a partial chain is the sum of the measured values of the route elements of the partial chain. This is especially advantageous inasmuch as the relevance of route segments made up of a plurality of route elements is thereby judged in a manner that is intuitively comprehensible to a user. For example, in case the travel distance is used as measured value, the total measured value corresponds precisely to the entire travel distance of the route segment made up of the route elements.

According to one specific embodiment of the present invention, the quantity of attributes encompasses special attributes. In addition, the display device has a special move-up unit, by which special attributes are moved up in the sequence of hierarchy levels. This specific embodiment is particularly advantageous because it allows possibly existing classifications of the attributes to be used in order to highlight especially relevant information.

According to one specific embodiment of the present invention, the quantity of attributes includes place-related attributes and route-related attributes. The display device has a place move-up unit, which moves a place-related attribute before a route-related attribute in the sequence of hierarchical levels if the partial chain of the route-related attribute has a first or last route segment that simultaneously is a route element of the partial chain of the place-related attribute.

In this specific development, the designation of a roadway extending along the route and leading out of or into a town appears below the town designation starting from the town's boundary. This has the advantage that the road's objectively subordinate role of linking the town is reflected in the display hierarchy, so that the displayed route is intuitively understood by the user in an especially rapid and efficient manner.

According to one specific embodiment, matching attributes of adjacent route elements within a hierarchy level are combined into one entry by the display unit. The display unit includes an operating element, which makes attributes of the next lower hierarchy level that are subordinate to the entry optionally visible. By masking lower hierarchy levels, it is thereby possible to display the route in compact form regardless of its length, which makes the embodiment especially suitable for compact navigation devices having small screens.

According to one specific embodiment, the operating element displays subordinate attributes of a place-related entry in the form of a tree topology. According to another specific embodiment, the operating element makes subordinate attributes of a route-related entry visible in that the entry providing a list of concatenations of the route-related attribute combined in the entry is replaced by an individual entry from the next-lower hierarchy level. The advantage of these structures is that they model the spatial order of the real world and thus are easy to comprehend: For a larger town corresponds to a spatially extended region, in which traffic routes and smaller towns are located, whereas attributes that are subordinate to a route-related attribute represent additional information pertaining to the same traffic route.

Under an additional aspect of the present invention, a navigation system for navigating along a travel route is provided, which has a display device for displaying the travel route as recited in one of the preceding claims. Such a navigation system is characterized by providing the required information to a traveling user, in particular a user driving a vehicle, with especially high efficiency, so that he is able to navigate along the route more rapidly and pay greater attention to the surroundings.

Furthermore, under an additional aspect of the present invention, a method for displaying a travel route is provided, in particular using a display device according to the present invention, in which a chain of route elements of the travel route is specified, and each route element has a measured value and a quantity of attributes.

### BRIEF DESCRIPTION OF THE DRAWINGS

FIG. 1 is a schematic representation of one example of a travel route;

FIG. 2 is a schematic representation of one specific embodiment of a display device according to the present invention;

FIG. 3 is a schematic representation of one specific embodiment of a navigation system according to the present invention;

FIG. 4 is one example of a route displayed with the aid of the display device of the present invention;

FIG. 5 is a flow chart of a method for displaying a travel route according to the present invention.

### DETAILED DESCRIPTION

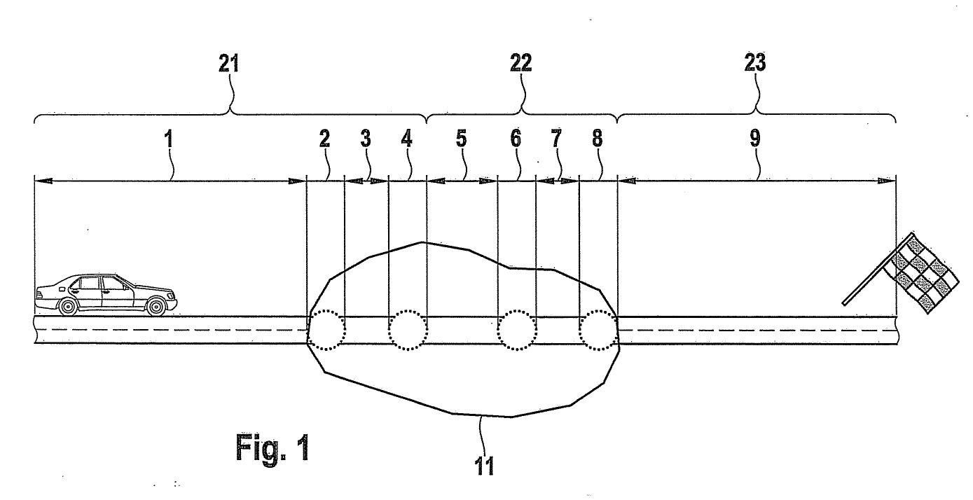

FIG. 1 shows a schematic, exemplary representation of a travel route in the manner of a stylized map as it is ascertained by conventional navigation or route planning systems. The route connects a starting point, marked by a vehicle in this case, and a destination, which is marked by a flag symbol. It is made up of a number of route elements 1 through 9, which—arranged in a specific sequence next to each other—subsequently form a chain, first route element 1 beginning at the starting point of the trip, and last route element 9 ending at the destination of the trip. Examples of route elements are both segments 1, 3, 5, 7, 9 of road networks such as roads, railway tracks or ferry routes, as well as traffic nodes 2, 4, 6, 8 such as intersections, railway stations or ports. Each route segment is assigned a portion of a travel distance of the entire travel route, the travel distance having the value of zero in the case of traffic nodes. In contrast, a travel time required to travel along a specific route element need not necessarily have a zero value even in the case of traffic nodes, since waiting times at traffic lights or railway stations, for example, contribute to the overall traveling time of the route.

Each route element of such a travel route may have one or more attributes, which denote or describe it in different ways or which include supplementary information relevant for the route element. For example, a road may be denoted by one or more road numbers or road names, which apply to a section of the road represented by the route element.

For better understanding, the elements of the route shown in FIG. 1 are summarized in table 1 with their respective travel distance, travel time and attributes.

TABLE 1
Output data of an exemplary route course

| Route | Travel | Traveling | Place | Road | Street | Intersection |
|---|---|---|---|---|---|---|
| Element | Distance | Time | Name | Number | Name | Designation |
| 1 | 1000 m | 10:00 | — | 21 | — | — |
| 2 | 0 m | 00:00 | 11 | 21 | — | 41 |
| 3 | 250 m | 10:00 | 11 | 21 | — | — |
| 4 | 0 m | 00:15 | 11 | 21 | — | — |
| 5 | 500 m | 20:00 | 11 | 22 | 31 | — |
| 6 | 0 m | 00:05 | 11 | 22 | 31 | 42 |
| 7 | 250 m | 15:00 | 11 | 22 | 32 | — |
| 8 | 0 m | 00:00 | 11 | 22 | 32 | — |
| 9 | 1000 m | 12:00 | — | 23 | — | — |

The attributes of the route elements have been symbolically represented by reference numerals 11-42 in table 1 and sorted into categories “place name”, “road number”, “street name” and “intersection designation” according to their meaning. Attributes are not available for all route elements in each category.

As illustrated in FIG. 1, starting with route element 2 up to and including route element 8, the route considered by way of example leads through a region 11, which represents a small town. Accordingly, a place name of region 11 is assigned to each of route elements 2 through 8, e.g., the place name of “Hildesheim”, in table 1. Also marked in FIG. 1 is the number of a road 21, which applies to route elements 1 through 4, e.g., the number of a federal highway “B21”. Since route element 1 lies outside region 11 but route elements 2 to 3 lie within region 11, the route follows road 21 into the interior of region 11. An additional road number 22 applies to following route elements 5 to 8, up to the border of region 11, and a third road number 23 applies to final route element 9 once region 11 has been left.

Along route elements 5 to 6, road 22 bears a street name 31, e.g., “Beethovenstrasse”, in addition to its road number, and along route elements 7 to 8, it bears an additional road name 32. Route elements 2 and 6, which correspond to intersections, are once again denoted by special intersection designations, which may be numbers or also names, for example.

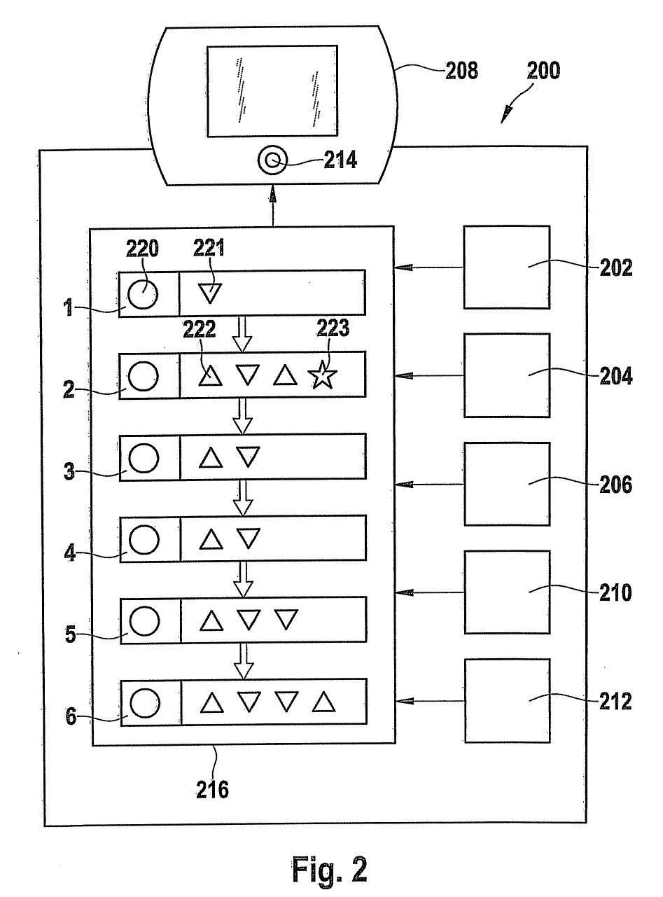

FIG. 2 shows as a schematic illustration a specific embodiment of a display device 200 according to the present invention for the display of a travel route, e.g., the route shown in FIG. 1. The display device includes a display unit 208 having a screen on which the route to be displayed appears during operation, and an operating element 214, with whose aid an operator is able to control the display of the travel route interactively.

The display device preferably includes a memory 216 for storing a data structure, which represents the travel route to be displayed in the form of a chain of route elements 1 to 6 shown here by way of example. The number of route elements of the chain depends on the travel route to be displayed, so that it is useful to select memory 216 sufficiently large to allow the storing of longer travel routes as well.

Each of the exemplarily shown route elements 1 to 6 has a measured value 220, which is a measure for the share of the particular route elements in the entire route. The travel distance, the travel time, the energy consumption or the transportation cost, for example, or a function derived from one or several of these values may be used as measured value. In addition, each route element has a quantity of attributes 221 to 223, which are categorized as route-related attributes 221 such as road names and numbers, place-related attributes 222 such as intersection designations, place and region names, or as special attributes 223 with special importance, such as dynamic traffic information, for example.

The display device includes a number of operating units 202, 204, 206, 210, 212, which perform operations on the chain of route elements stored in memory 216, in order to bring them into suitable condition for display by display unit 208. These operating units may be realized in the form of program modules implemented by a microprocessor, for example, or in the form of hardware modules. The operating units include a partial chain ascertainer 202 for ascertaining partial chains of the chain of route elements 1 to 6, a calculation unit 204, a sorter 206, and preferably also a place move-up unit 212, as well as a special move-up unit 210, whose methods of functioning will be described in the following text using as example the data of the travel route listed in table 1 from FIG. 1.

During operation, display device 200 receives a data structure which represents a chain of route elements 1 to 9 of a travel route from an external route planning system, for example. This data structure is stored in memory 216 for further processing. As an alternative, memory 216 may be part of the route planning system that has determined the route, so that the separate storing by display device 200 may be omitted.

For each attribute of at least one route element, partial chain ascertainer 202 then determines a continuous partial chain having a maximum length of route elements, including the route element, that have an identical attribute. For example, partial chain ascertainer 202 begins with first route element 1, which has the road number 21 as attribute according to table 1. The partial chain ascertainer then checks whether adjacent route element 2 also includes road number 21 as attribute. Since this is the case according to table 1, the partial chain ascertainer also checks for route element 3 adjacent to route element 2 whether it has road number 21 as attribute, and so forth for the subsequent route elements. When checking the attributes of route element 5, the partial chain ascertainer no longer detects road number 21 and as a result provides the determined continuous partial chain of route elements 1 to 4, all of which have the identical attribute of road number 21.

Partial chain ascertainer 202 thereupon repeats the described operation, for instance next for the not yet considered attributes of route element 2, and in this way determines an additional continuous partial chain of route elements 2 to 8, all of which have the identical attribute of place name 11. A third partial chain includes route element 2 as single route element since it includes intersection designation 41 as attribute in contrast to its two neighbor elements 1 and 3. In this manner partial chain ascertainer 202 assigns precisely one continuous partial chain of route elements to each attribute.

After the operation of partial chain ascertainer 202 has been concluded, calculation unit 204 uses the measured values of the route elements of the partial chain to calculate a total measured value for each determined partial chain. In the following text, the travel distance is used as measured value of the particular route elements 1 to 9 by way of example. Calculation unit 204 begins with, for instance, the continuous partial chain of route elements 1 to 4 ascertained by partial chain ascertainer 202, all of which have road number 21 as identical attribute, and adds up the travel distances of route elements 1 to 4. Since route element 1 has a travel distance of 1000 m, route element 3 a travel distance of 250 m, and route elements 2 and 4 have a travel distance of 0 m, a total measured value of 1,250 m results for this partial chain.

Calculation unit 204 carries out corresponding calculations of a total measured value for the remaining partial chains. The result on the basis of the exemplary route is summarized in table 2. For better understanding of the following operations, for each partial chain the total measured value of the partial chain has been placed behind each attribute of this partial chain in parentheses.

TABLE 2
Total measured values of the partial chains for the
exemplary route course

| Route | | | | | |
|---|---|---|---|---|---|
| Ele- | Travel | Place | Road | Street | Intersection |
| ment | Distance | Name | number | Name | Designation |
| 1 | 1,000 m | — | 21 (1,250 m) | — | — |
| 2 | 0 m | 11 | 21 (1,250 m) | — | 41 (0 m) |
| | | (1,000 m) | | | |
| 3 | 250 m | 11 | 21 (1,250 m) | — | — |
| | | (1,000 m) | | | |
| 4 | 0 m | 11 | 21 (1,250 m) | — | — |
| | | (1,000 m) | | | |
| 5 | 500 m | 11 | 22 (750 m) | 31 (500 m) | — |
| | | (1,000 m) | | | |
| 6 | 0 m | 11 | 22 (750 m) | 31 (500 m) | 42 (0 m) |
| | | (1,000 m) | | | |
| 7 | 250 m | 11 | 22 (750 m) | 32 (500 m) | — |
| | | (1,000 m) | | | |
| 8 | 0 m | 11 | 22 (750 m) | 32 (500 m) | — |
| | | (1,000 m) | | | |
| 9 | 1,000 m | — | 23 (1,000 m) | — | — |

Once partial chain ascertainer 202 has assigned a partial chain to each attribute of the route elements, and once calculation unit 204 has assigned a total measured value to each partial chain, the total measured value of its associated partial chain has thus been indirectly assigned to each attribute. This value is the travel distance noted behind the particular attributes in parentheses in table 2.

For one of route elements 1 to 9 in each case, sorter 206 then sorts the quantity of attributes of this route element into a sequence of hierarchical levels according to a quantitative relation of the total measured values of the partial chains of the attributes. With respect to the representation in table 2, this means that the attributes appearing in the same line are sorted according to the total measured value noted behind them in parentheses. For instance, sorter 206 starts with the first route element 1 of the route. This route element 1 has road number 21 as sole attribute, which sorter 206 assigns to a first, uppermost hierarchy level of the sequence of hierarchical levels. According to table 2, route element 2 has three attributes having different total measured values of the associated partial chains. From among these, the sorter determines road number 21 as attribute with the greatest total measured value of 1,250 m and therefore assigns road number 21 to the first hierarchy level. Place name 11 has the second-largest total measured value of 1,000 m and thus is sorted into the second hierarchy level. Intersection designation 41 with the smallest total measured value of 0 m is sorted into the third hierarchy level. The attributes sorted into the sequence of hierarchical levels by the operation of sorter 206 for all route elements 1 to 9 are summarized in table 3 for the exemplary route.

TABLE 3
Attributes of the route elements sorted
according to total measured value

| Route | 1. Hierarchy | 2. Hierarchy | 3. Hierarchy | 4. Hierarchy |
|---|---|---|---|---|
| Element | Level | Level | Level | Level |
| 1 | 21 (1,250 m) | — | — | — |
| 2 | 21 (1,250 m) | 11 (1,000 m) | 41 (0 m) | — |
| 3 | 21 (1,250 m) | 11 (1,000 m) | — | — |
| 4 | 21 (1,250 m) | 11 (1,000 m) | — | — |
| 5 | 11 (1,000 m) | 22 (750 m) | 31 (250 m) | — |
| 6 | 11 (1,000 m) | 22 (750 m) | 31 (250 m) | 42 (0 m) |
| 7 | 11 (1,000 m) | 22 (750 m) | 32 (250 m) | — |
| 8 | 11 (1,000 m) | 22 (750 m) | 32 (250 m) | — |
| 9 | 23 (1,000 m) | — | — | — |

In this manner the attributes have already been brought into suitable condition for display in a hierarchical view by display unit 208. At this point special move-up unit 210 may correct the sorting of the attributes in order to assign a higher hierarchical level to attributes that have been rated very important as a result of a previously known classification. Additional corrections of the sorting are made by place move-up unit 212, which may be undertaken both prior to and also following possible corrections by special move-up unit 210.

During operation, to correct the sorting, place move-up unit 212 moves a place-related attribute in the sequence of hierarchical levels above a route-related attribute if the partial chain of the route-related attribute has a first or last route segment that simultaneously is a route element of the partial chain of the place-related attribute. For route element 2, for instance, place name 11, which is a place-related attribute, is listed in the second hierarchy level behind road number 21, which is a route-related attribute. Place move-up unit 212 then checks for the first and last route element of the partial chain of road number 21, i.e., route elements 1 and 4, whether these are also route elements of the partial chain of place name 11. Place move-up unit 212 determines that this applies to route element 4 and therefore moves place name 11 and places it above road number 21 for monitored route element 2, so that they switch places in the sequence of hierarchical levels. In analogous manner, place move-up unit 212 likewise moves place name 11 above road number 21 for route elements 3 and 4.

Additional place-related attributes of the exemplary route are intersection designations 41 and 42. For route element 2, intersection designation 41 appears below road number 21 in the hierarchy. The place move-up unit checks for the first and last route element of the partial chain of road number 21, i.e., route elements 1 and 4, whether they, too, are route elements of the partial chain of intersection designation 41. Since this is not the case, the sorting remains unchanged here. For route element 6, intersection designation 42 appears below road name 31 in the hierarchy. The place move-up unit checks for the first and last route element of the partial chain of the road name, i.e., route elements 5 and 6, whether they, too, are route elements of the partial chain of intersection designation 42. Since this is the case for route element 6, road name 31 and intersection designation 42 switch places here. Intersection designation 42 is not moved up further since neither the first nor the last route element of the partial chain of road number 22 is a route element of the partial chain of intersection designation 42.

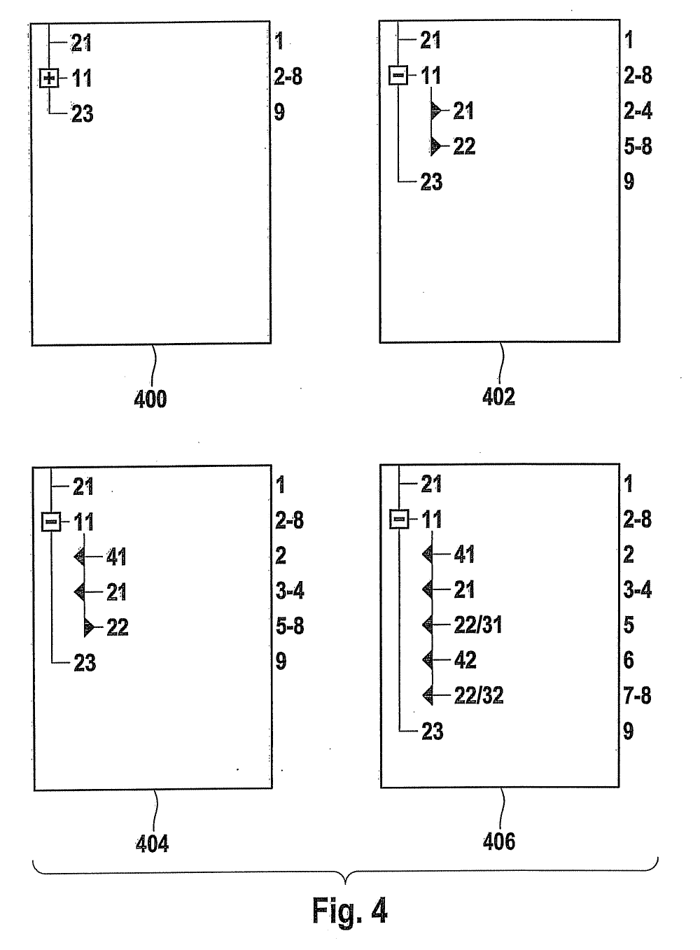

The final sorting of the attributes of the exemplary route into the sequence of hierarchical levels, as corrected by place move-up unit 212, is illustrated in table 4. As described in greater detail in the description of FIG. 4, display unit 208 displays the attributes of route elements 1 to 9 in a hierarchical representation according to their distribution to the hierarchy levels shown in table 4.

TABLE 4
Attribute sorting corrected by the place move-up unit.

| Route | 1. Hierarchy | 2. Hierarchy | 3. Hierarchy | 4. Hierarchy |
|---|---|---|---|---|
| Element | Level | Level | Level | Level |
| 1 | 21 (1,250 m) | — | — | — |
| 2 | 11 (1,000 m) | 21 (1,250 m) | 41 (0 m) | — |
| 3 | 11 (1,000 m) | 21 (1,250 m) | — | — |
| 4 | 11 (1,000 m) | 21 (1,250 m) | — | — |
| 5 | 11 (1,000 m) | 22 (750 m) | 31 (500 m) | — |
| 6 | 11 (1,000 m) | 22 (750 m) | 42 (0 m) | 31 (500 m) |
| 7 | 11 (1,000 m) | 22 (750 m) | 32 (250 m) | — |
| 8 | 11 (1,000 m) | 22 (750 m) | 32 (250 m) | — |
| 9 | 23 (1,000 m) | — | — | — |

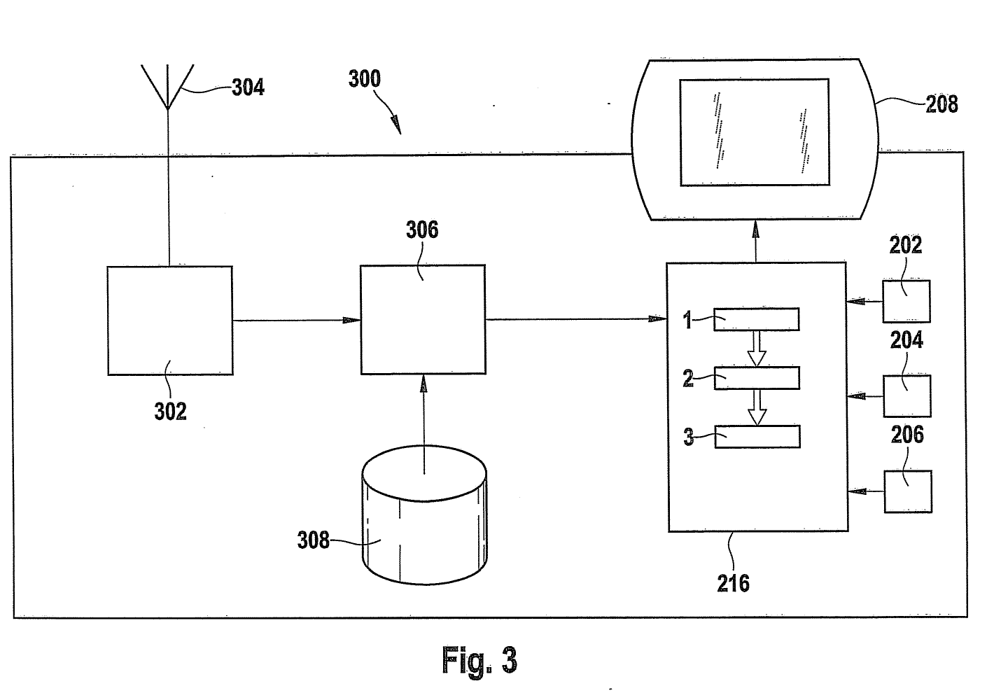

FIG. 3 shows a specific embodiment of a navigation system 300 according to the present invention in a schematic representation. Navigation system 300 includes a navigation unit 302, which receives radio signals with the aid of an antenna 304 and uses them to determine a geographical position. A route-planning unit 306 utilizes data from a cartographic database 308 to plan a route from the current geographic position to a specified destination and stores this route as a chain of route elements 1, 2, 3 in memory 216, each route element having a measured value and a quantity of attributes, which have been taken from database 308, for example. The navigation system also has a partial chain ascertainer 202, a calculation unit 204, and a sorter 206, which in conjunction with a display unit 208 form a display device according to the present invention and execute the above-described corresponding operations on the route elements stored in memory 216 during operation, thereby making it possible to display the route planned by route planning unit 306 with the aid of display unit 208 in a corresponding hierarchical representation, which will be explained in the following text for the data from table 1 by way of example.

FIG. 4 shows a screen content of display unit 208 in four stages 400, 402, 404, 406 in the interactive display of the data from table 1, in a hierarchical representation of the attributes of the route elements according to their sorting into the sequence of hierarchy levels according to table 4.

For easier explainability, the attributes of the route elements have been symbolically replaced by their respective reference numerals 11 to 42, as already done in table 1.

Stage 400 of the screen content shows the exemplary route in very compact form, in which only attributes 21, 11, 23 of the highest hierarchy level are visible. Identical attributes of adjacent route elements lying on the same hierarchy level are combined into one entry. To make this clear, numbers at the right margin of the screen content point to the route elements combined into the individual entry appearing above them; they are not part of the screen content. Visible are road name 21, place name 11, and street number 23, the single entry of place name 11 being generated by combining identical attributes from the highest hierarchy level of route elements 2 to 8. The box appearing before place name 11 and bearing a “+” marking tells the user that additional attributes in lower hierarchy levels are available below this attribute and that they may be made visible by using operating element 214, if necessary.

When operating element 214 is actuated, a second stage 402 of the screen content is displayed. In the second hierarchy level, the road numbers 21 and 22 are now visible underneath place name 11, while the “+” marking has changed to a “−” marking in order to indicate the expanded state of the associated attribute. Once again, the black triangles pointing to the right tell the user that additional attributes in lower hierarchy levels are available below road numbers 21 and 22 and that they may be made visible by using operating element 214, if necessary. The appearance of these triangles . . . from the box with the “+” marking in stage 400 . . . also characterizes road numbers 21 and 22 as route-related attributes, in contrast to place-related attributes such as place name 11, and it correlates with a different method of functioning when operating element 214 is actuated, so that the semantic difference becomes clear in a manner that facilitates the user's comprehension.

For example, if the user selects road number 21 in the third line of stage 402 and actuates operating element 214, then a screen content similar to that in stage 404 will be obtained. Instead of road number 21 in the third line, intersection designation 41 and, below it, road number 21 are now visible, corresponding to the three route elements 2 to 4, the last two of which have been combined into one entry because of identical attributes. The triangle preceding these entries, which now point to the left, informs the user that no further attributes able to be made visible are available directly below these attributes.

If the user then selects road number 22 and actuates operating element 214, a screen contents as in stage 406 will result. While intersection designations 41 and 42 are shown on their own in each case, road names 31 and 32 have road number 22 placed before them. This corresponds to a special rule according to which route- and place-related attributes are not combined into a single entry of the display so as not to blur their semantic difference. In contrast, a plurality of route-related attributes is combined, which makes it clear that they pertain to the same road segment. Route elements 7 to 8 appear as individual entry since their attributes are identical, so that the subdivision of the corresponding road segment to the two route elements 7 and 8 is meaningless for the user.

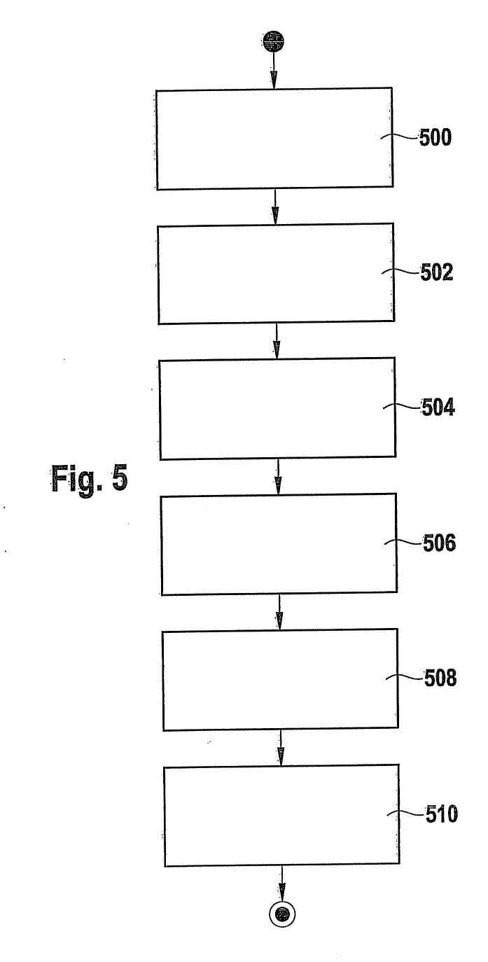

FIG. 5 shows a flow chart of one specific embodiment of a method according to the present invention for the display of a travel route, for instance with the aid of a display device as shown in FIG. 2. In step 500, the travel route is specified in the form of a chain of route elements, each route element having a measured value and a quantity of attributes. In step 502, a continuous partial chain having a maximum length of route elements, including the route element, that have an identical attribute is ascertained for each attribute of at least one route element. In step 504, a total measured value is calculated for each partial chain, using the measured values of the route elements of the partial chain. In step 506, the quantity of attributes for the at least one route element is sorted into a sequence of hierarchy levels according to a quantitative relation of the total measured values of the partial chains of the attributes. In step 508, special attributes in the sequence of hierarchy levels are moved up, and in step 510, the attributes of the at least one route element are displayed in a hierarchical representation according to the hierarchy level.

1-11. (canceled)

12. A display device for displaying a travel route including a chain of route elements, each route element having a measured value and a quantity of attributes, comprising:
a partial chain ascertainer adapted to determine for each attribute of at least one route element a continuous partial chain of route elements having a maximum length, including the route element, that have an identical attribute;
a calculation unit adapted to calculate a total measured value from the measured values of the route elements of the partial chain for each partial chain;
a sorter adapted to sort the quantity of attributes into a sequence of hierarchy levels for the at least one route element according to a quantitative relation of the total measured values of the partial chains of the attributes; and
a display unit adapted to display the attributes of the at least one route element in a hierarchical display according to the hierarchy levels.

13. The display device according to claim 12, wherein the measured value of a route element is a function of a travel route and a travel time of the route element and is the travel distance.

14. The display device according to claim 12, wherein the total measured value of a partial chain is a sum of the measured values of the route elements of the partial chain.

15. The display device according to claim 12, wherein the quantity of attributes includes special attributes, and the display device also has a special move-up unit, by which special attributes are moved up in the sequence of hierarchy levels.

16. The display device according to claim 12, wherein the quantity of attributes includes place-related attributes and route-related attributes, and the display device also has a place move-up unit adapted to move a place-related attribute before a route-related attribute in the sequence of hierarchy levels if the partial chain of the route-related attribute has a first or last route element that simultaneously is a route element of the partial chain of a place-related attribute.

17. The display device according to claim 16, wherein the display unit is adapted to combine matching attributes of adjacent route elements within a hierarchy level into one entry, and it has an operating element adapted to make attributes of a next lower hierarchy level that are subordinate to an entry optionally visible, the operating element being specifically designed to make subordinate attributes of a place-related entry visible in the form of a tree structure.

18. The display device according to claim 17, wherein the operating element is adapted to display subordinate attributes of a route-related entry by replacing the entry including a list of concatenations of the route-related attribute that are combined in the entry, with an individual entry from the next-lower hierarchy level.

19. A navigation system for navigating along a travel route, comprising:
a display device for displaying the travel route according to claim 12.

20. A method for displaying a travel route, comprising:
a) specifying a chain of route elements of the travel route, each route element having a measured value and a quantity of attributes;
b) determining for each attribute of at least one route element a continuous partial chain having a maximum length of route elements, including the route element, that have an identical attribute;
c) calculating a total measured value for each partial chain from the measured values of the route elements of the partial chain;
d) sorting the quantity of attributes for the at least one route element into a sequence of hierarchy levels according to a quantitative relation of the total measured values of the partial chains of the attributes; and
e) displaying the attributes of the at least one route element in a hierarchical representation according to the hierarchy levels.

21. The method according to claim 20, wherein the measured value of a route element is a travel route of the route element, and the calculation of the total measured value is implemented by summing up the travel routes of the route elements of the partial chain.

22. The method according to claim 20, wherein the quantity of attributes includes place-related attributes and route-related attributes, and the method also includes moving up place-related attributes, a place-related attribute in the sequence of hierarchy levels being moved before a route-related attribute if the partial chain of the route-related attribute has a first or last route element that simultaneously is a route element of the partial chain of the place-related attribute.
